(19) United States
(12) Patent Application Publication
(10) Pub. No.: US 2020/0110889 A1
(43) Pub. Date: Apr. 9, 2020

(54) RECORDING MEDIUM STORING CACHE CONTROL PROGRAM, CACHE CONTROL METHOD, AND PROXY SERVER

(71) Applicant: FUJITSU LIMITED, Kawasaki-shi (JP)

(72) Inventor: Nobuyuki Hashimoto, Machida (JP)

(73) Assignee: FUJITSU LIMITED, Kawasaki-shi (JP)

(21) Appl. No.: 16/556,887

(22) Filed: Aug. 30, 2019

(30) Foreign Application Priority Data
Oct. 3, 2018 (JP) 2018-188294

(51) Int. Cl. G06F 21/60; H04L 9/14; H04L 29/08

(52) U.S. Cl. CPC G06F 21/602; H04L 67/42; H04L 67/2842; H04L 9/14

(57) ABSTRACT

A cache method between a server and a device includes: determining, when a first request which includes an encrypted data acquisition request and an identifier in plaintext is received from the device, whether or not cache data corresponding to the identifier is stored in a storage. When the cache data is stored, transmitting to the device a first response including the cache data. When the cache data is not stored, transmitting to the server a second request acquired by deleting the identifier from the first request and a third request for requesting the acquisition of the data; when a second response to the second request is received from the server, transmitting the second response to the device; and when a third response to the third request is received from the server, storing the cache data in the third response in association with the identifier in the storage.

### CROSS-REFERENCE TO RELATED APPLICATION

This application is based upon and claims the benefit of priority of the prior Japanese Patent Application No. 2018-188294, filed on Oct. 3, 2018, the entire contents of which are incorporated herein by reference.

### FIELD

The embodiments discussed herein are related to a non-transitory computer-readable recording medium storing a cache control program, a cache control method, and a proxy server.

### BACKGROUND

Access to a server over the Internet from a terminal device within an intranet is performed through, for example, a proxy server. The proxy server relays a packet communicated between the intranet and the Internet.

At the time of relaying the packet, the proxy server is able to cache data acquired by the terminal device within the Intranet from the server over the Internet. There are some cases where a request for requesting acquisition of the same data is output from the terminal device within the Intranet after the proxy server caches the data. In this case, the proxy server transmits data (cache data) to be cached to the terminal device as a response instead of transmitting the request to the server over the Internet. According, it is possible to increase efficiencies of acquisition processing of the data provided by the server over the Internet in the terminal device.

For example, there are some cases where each of a plurality of terminal devices within the intranet acquires the same data provided by the server over the Internet. In this case, the data initially transmitted to the terminal device that accesses to the server is cached in the proxy server. The proxy server transmits the cached data to the corresponding terminal device when the other terminal device accesses to the server. Accordingly, efficiencies of the data acquisition processing from the server in the second and subsequent terminal devices are increased.

For example, a client/server system that reduces the amount of communication data in the encrypted communication is considered as a technology related to the increasing of efficiencies of the communication over a network. An information providing system in which a plurality of servers is used as targets and includes a proxy capable of performing data processing on data acquired by decrypting encrypted data when the data is encrypted and exchanged between each server and each client is also considered. A suffix proxy that manages Software as a Service (SaaS) server response such that the subsequent request is handled according to a file type and a response type is also considered.

Japanese Laid-open Patent Publication No. 2005-63032, Japanese Laid-open Patent Publication No. 2004-206573, and Japanese National Publication of International Patent Application No. 2017-504092 are examples of related art.

For example, there are some cases where communication between the terminal device and the server is performed while being encrypted by using a technology such as Hypertext Transfer Protocol Secure (HTTPS). The encrypted communication data (encrypted data) is able to be decrypted by only the terminal device and the server that communicate with each other, and is not able to be decrypted by the proxy server. Thus, the proxy server is not able to cache the relayed encrypted data as plaintext. Even though the encrypted data is cached in the proxy server, the cached encrypted data is not able to be decrypted in terminal devices other than the terminal device that acquires the encrypted data from the server through the encrypted communication, and thus, the efficiencies of the processing are not able to be increased.

According to an aspect of the embodiments, it is possible to cache data which is encrypted and communicated as plaintext.

### SUMMARY

According to an aspect of the embodiments, a proxy server performs a cache method, between a server and a device. The method includes: determining, when a first request which includes an encrypted data acquisition request for requesting acquisition of data within the server and an identifier, in plaintext, of the data and is addressed to the server is received from the device, whether or not cache data corresponding to the identifier is stored in a storage; transmitting, when the cache data is stored in the storage, to the device, a first response including the cache data; transmitting, when the cache data is not stored in the storage, to the server, a second request acquired by deleting the identifier from the first request and transmitting, to the server, a third request for requesting the acquisition of the data; transmitting, when a second response to the second request is received from the server, to the device, the second response; and storing, when a third response to the third request is received from the server, as the cache data, the data included in a third response in association with the identifier in the storage.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a cache control method according to a first embodiment;

FIG. 2 is a diagram illustrating an example of a system configuration according to a second embodiment;

FIG. 3 is a diagram illustrating an example of a hardware configuration of a proxy server;

FIG. 4 is a block diagram illustrating a function for implementing encrypted communication with caching;

FIG. 5 is a diagram illustrating an example of data within a cache data storage unit;

FIG. 6 is a diagram illustrating an example of a packet format for encrypted communication;

FIG. 7 is a diagram illustrating an outline of data caching in the proxy server;

FIG. 8 is a sequence diagram illustrating an example of a communication processing procedure including data caching;

FIG. 9 is a flowchart illustrating an example of a procedure of encrypted communication processing in a browser;

FIG. 10 is a diagram illustrating an example of a request of a GET request;

FIG. 11 is a diagram illustrating an example of a request of a POST request;

FIG. 12 is a diagram illustrating an example of a packet of a request including URL information;

FIG. 13 is a flowchart illustrating an example of a procedure of packet relay processing in a TLS packet processing unit;

FIG. 14 is a flowchart illustrating an example of a procedure of data for cache acquisition processing;

FIG. 15 is a diagram illustrating an example of a response with an expiration date of data; and

FIG. 16 is a diagram illustrating an example of a packet for transmitting cache data as a response.

### DESCRIPTION OF EMBODIMENTS

Hereinafter, embodiments will be described with reference to the drawings. The embodiments are able to be implemented by combining a plurality of embodiments without any contraction.

### First Embodiment

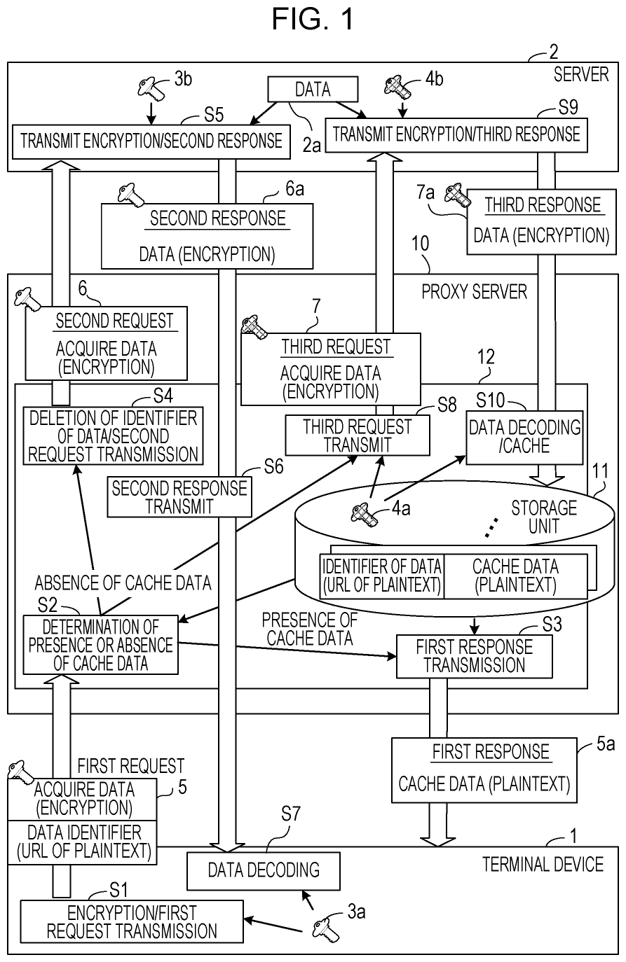

FIG. 1 is a diagram illustrating an example of a cache control method according to the first embodiment; In FIG. 1, an example of a case where the cache control method is implemented by using a proxy server 10 is illustrated. The proxy server 10 is able to implement the cache control method by executing, for example, a cache control program in which a processing procedure of the cache control method is described.

The proxy server 10 includes a storage unit 11 and a processing unit 12 in order to implement the cache control method. The storage unit 11 is, for example, a storage device or a memory included in the proxy server 10. The processing unit 12 is, for example, an arithmetic circuit or a processor included in the proxy server 10.

The storage unit 11 stores cache data items of data items in association with identifiers of a plurality of data items relayed by the proxy server 10. The storage unit 11 stores a key (second key 4a) for encrypted communication with a server 2.

The processing unit 12 caches data relayed by the proxy server 10. In the example of FIG. 1, the proxy server 10 is coupled to a terminal device 1 via an intranet, and is coupled to the server 2 via the Internet. The proxy server 10 relays communication between the terminal device 1 and the server 2. On this occasion, there are some cases where the terminal device 1 and the server 2 perform encrypted communication. The processing unit 12 is able to cache the data even though the relayed data is encrypted.

When the terminal device 1 and the server 2 perform the encrypted communication, the terminal device 1 and the server 2 cooperate with each other, and the terminal device 1 and the server 2 generate first keys 3a and 3b having the same content to be used for encryption and decryption, respectively. The terminal device 1 and the server 2 communicate pieces of information encrypted with the first keys 3a and 3b. When data 2a owned by the server 2 is acquired by the terminal device 1, a process of acquiring the data 2a and a process of caching the data in the processing unit 12 are performed in the following procedure.

Initially, the terminal device 1 encrypts a data acquisition request for requesting the acquisition of the data 2a within the server 2, and transmits the encrypted data acquisition request and a first request 5 addressed to the server 2 which includes an identifier (acquisition target data identifier) of a plaintext of the data 2a (acquisition target data) (step S1). The identifier of the data is, for example, a Uniform Resource Locator (URL) of the plaintext of the data. The first request 5 is relayed by the proxy server 10. The identifier of the data 2a is also included in the encrypted data acquisition request.

When the first request 5 is received, the processing unit 12 of the proxy server 10 determines whether or not the cache data (corresponding cache data) corresponding to the identifier of the data is stored in the storage unit 11 (step S2). When the corresponding cache data is stored in the storage unit 11, the processing unit 12 transmits a first response 5a including the cache data to the terminal device 1 which is a transmission source of the first request 5 (step S3). In this case, the cache data of the plaintext is transmitted to the terminal device 1. On this occasion, the processing unit 12 may add information indicating that the cache data within the first response 5a is the plaintext to the first response 5a. Accordingly, the terminal device 1 that receives the first response 5a is able to recognize that the cache data is the plaintext, and is able to appropriately process the data 2a. That is, when there is the data of the plaintext in response to the first request 5 transmitted through the encrypted communication, the terminal device 1 skips a decryption process of the data in the encrypted communication, and is able to handle the received data as decrypted data.

When the corresponding cache data is not stored in the storage unit 11, the processing unit 12 transmits a second request 6 acquired by deleting the identifier of the data 2a from the first request 5 to the server 2 (step S4). Since the identifier of the data 2a is deleted, a leakage of the identifier of the data 2a as an access target over a communication path between the proxy server 10 and the server 2 is restrained. Since the identifier of the data 2a is also included in the data acquisition request but the data acquisition request is encrypted, other devices other than the server 2 is not able to extract the identifier of the data 2a from the data acquisition request.

The server 2 that receives the second request 6 transmits the data 2a, as a response. For example, the server 2 encrypts the data 2a with the first key 3b, and transmits a second response 6a including the encrypted data 2a to the proxy server 10 (step S5).

When the second response 6a to the second request 6 is received from the server 2, the processing unit 12 of the proxy server 10 transmits the second response 6a to the terminal device 1 which is the transmission source of the first request 5 (step S6). The terminal device 1 that receives the second response 6a decrypts the data 2a within the second response 6a with the first key 3a (step S7).

When the corresponding cache data is not stored in the storage unit 11, the processing unit 12 transmits a third request 7 for requesting the acquisition of the data 2a to the server 2 (step S8). For example, the processing unit 12 and the server 2 cooperate with each other, and the processing unit 12 and the server 2 generate second keys 4a and 4b having the same content to be used for encryption and decryption. For example, the processing unit 12 stores the generated second key 4a in the storage unit 11. The processing unit 12 encrypts the data acquisition request for requesting the acquisition of the data 2a within the server 2 with the second key 4a, and transmits the third request 7 including the encrypted data acquisition request to the server 2. The processing unit 12 is able to perform the transmission of the third request 7 at any timing in a thread different from the transmission of the second request 6. For example, the processing unit 12 may simultaneously perform the second request 6 and the third request 7. The processing unit 12 may transmit the third request 7 after the second response 6a to the second request 6 is transmitted.

The server 2 that receives the third request 7 transmits the data 2a, as a response. For example, the server 2 encrypts the data 2a with the second key 4b, and transmits a third response 7a including the encrypted data 2a to the proxy server 10 (step S9).

When the third response 7a to the third request 7 is received from the server 2, the processing unit 12 of the proxy server 10 stores, as the cache data, the data 2a included in the third response 7a in association with the identifier of the plaintext included in the first request in the storage unit 11. For example, when the third response 7a is received through the encrypted communication, the processing unit 12 decrypts the encrypted data 2a included in the third response 7a with the second key 4a, and stores the decrypted data 2a in association with the identifier in the storage unit 11 (step S10).

The data 2a acquired by the terminal device 1 from the server 2 through the encrypted communication in this manner is able to be cached as the plaintext in the proxy server 10. As a result, efficiency in the process of acquiring the data from the server 2 through the encrypted communication is improved.

In particular, normal encrypted communication for not only communication requiring very high safety as in a case where online transactions in a bank are performed but also general communication has increased in recent years. The normal encrypted communication is performed, and thus, it is possible to restrain the leakage of important data even when the important data is mixed in with data having low importance without user's awareness. Each single communication is not important, but there are some cases where important information is extracted by combining and analyzing multiple communications. Thus, although individual communications are not important, it is possible to restrain the leakage of the important information by encrypting all communications. As the number of communication methods for performing the normal encrypted communication increases, it is important to increase efficiencies of processing for caching the data acquired through the encrypted communication in the proxy server 10.

### Second Embodiment

Next, a second embodiment will be described.

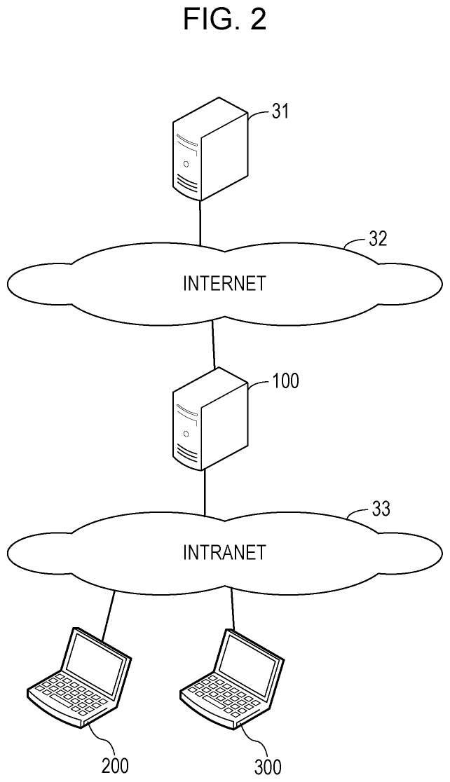

FIG. 2 is a diagram illustrating an example of a system configuration according to the second embodiment. A proxy server 100 is disposed between the Internet 32 to which a Web server 31 is coupled and an intranet 33 to which terminal devices 200 and 300 are coupled. The Web server 31 publishes various data items. The terminal devices 200 and 300 access to the Web server 31, and acquire the data published by the Web server 31.

The proxy server 100 relays communication between each of the terminal devices 200 and 300 and the Web server 31. The proxy server 100 has a data caching function. For example, the proxy server 100 caches the data transmitted to any of the terminal devices from the Web server 31, and retains the cache data. When a request for requesting the acquisition of the same data as the cache data is output from any of the terminal devices 200 and 300 to the Web server 31, the proxy server 100 transmits the cache data to the terminal device that transmits this request. Even when the encrypted communication is performed between the terminal device 200 or 300 and the Web server 31, the proxy server 100 is able to cache the data of the plaintext corresponding to the communicated encrypted data.

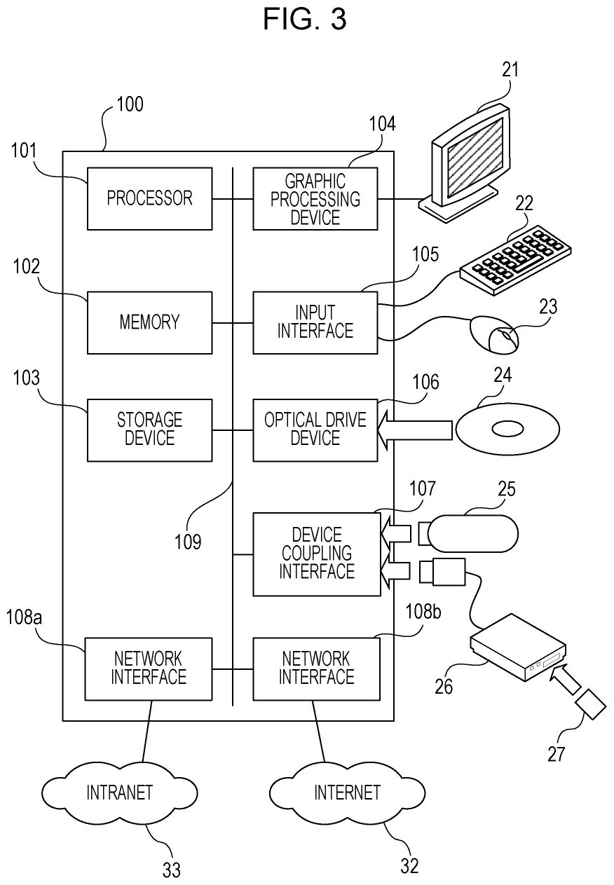

FIG. 3 is a diagram illustrating an example of a hardware configuration of the proxy server. The proxy server 100 is controlled by a processor 101 as a whole. A memory 102 and a plurality of peripheral devices are coupled to the processor 101 via a bus 109. The processor 101 may be a multiprocessor. The processor 101 is, for example, a central processing unit (CPU), a micro processing unit (MPU), or a digital signal processor (DSP). At least a part of functions implemented by the processor 101 executing a program may be implemented by an electronic circuit such as an application specific integrated circuit (ASIC) or a programmable logic device (PLD).

The memory 102 is used as a main storage device of the proxy server 100. At least a part of an operating system (OS) program and an application program which are executed by the processor 101 is temporarily stored in the memory 102. The memory 102 stores various kinds of data items to be used in processing by the processor 101. For example, a random-access memory (RAM) such as a volatile semiconductor storage device is used as the memory 102.

Examples of the peripheral devices coupled to the bus 109 include a storage device 103, a graphic processing device 104, an input interface 105, an optical drive device 106, a device coupling interface 107, and network interfaces 108a and 108b.

The storage device 103 electrically or magnetically writes and reads data to and out from a built-in recording medium. The storage device 103 is used as an auxiliary storage device of a computer. The storage device 103 stores an OS program, an application program, and various data. For example, a hard disk drive (HDD) or a solid state drive (SSD) is able to be used as the storage device 103.

A monitor 21 is coupled to the graphic processing device 104. The graphic processing device 104 displays an image on a screen of the monitor 21 in accordance with a command from the processor 101. Examples of the monitor 21 include a display device using an organic electroluminescence (EL) and a liquid crystal display device.

A keyboard 22 and a mouse 23 are coupled to the input interface 105. The input interface 105 transmits a signal sent from the keyboard 22 and the mouse 23 to the processor 101. The mouse 23 is an example of a pointing device, and other pointing devices are able to be used. Examples of the pointing devices include a touch panel, a tablet, a touch pad, and a trackball.

The optical drive device 106 reads data recorded in an optical disk 24 by using a laser beam. The optical disk 24 is a portable recording medium on which data is recorded so as to be readable via light reflection. The optical disk 24 includes a digital versatile disc (DVD), DVD-RAM, a compact disc-read only memory (CD-ROM), CD-Recordable (R)/Rewritable (RW) and the like.

The device coupling interface 107 is a communication interface for coupling a peripheral device to the proxy server 100. For example, a memory device 25 and a memory reader and writer 26 are able to be coupled to the device coupling interface 107. The memory device 25 is a recording medium having a function of communicating with the device coupling interface 107. The memory reader and writer 26 is a device for writing data to a memory card 27 or reading data from the memory card 27. The memory card 27 is a card-type recording medium.

The network interface 108a is coupled to the intranet 33. The network interface 108a transmits and receives data to and from the terminal device 200 or 300 via the intranet 33.

The network interface 108b is coupled to the Internet 32. The network interface 108b transmits and receives data to and from the Web server 31 via the Internet 32.

With the hardware configuration described above, the proxy server 100 is able to implement processing functions of the second embodiment. The Web server 31 and the terminal device 200 or 300 are able to be implemented by the same hardware configuration as the proxy server 100. The proxy server 10, the terminal device 1, and the Web server 2 illustrated in the first embodiment are able to be implemented by the same hardware as the proxy server 100 illustrated in FIG. 3.

For example, the proxy server 100 implements the processing functions of the second embodiment by executing a program recorded in a computer-readable recording medium. The program in which the processing contents to be executed by the proxy server 100 are described is able to be recorded in various recording medium. For example, the program to be executed by the proxy server 100 is able to be stored in the storage device 103. The processor 101 loads at least a part of programs within the storage device 103 into the memory 102, and executes the program. The program to be executed by the proxy server 100 is able to be recorded in a portable recording medium such as the optical disk 24, the memory device 25, or the memory card 27. For example, the program stored in the portable recording medium is able to be executed after this program is installed on the storage device 103 under the control of the processor 101. The processor 101 is able to directly read out the program from the portable recording medium, and is able to execute the program.

Hereinafter, a communication method capable of caching the data of the plaintext corresponding to the encrypted data in the proxy server 100 will be described in detail.

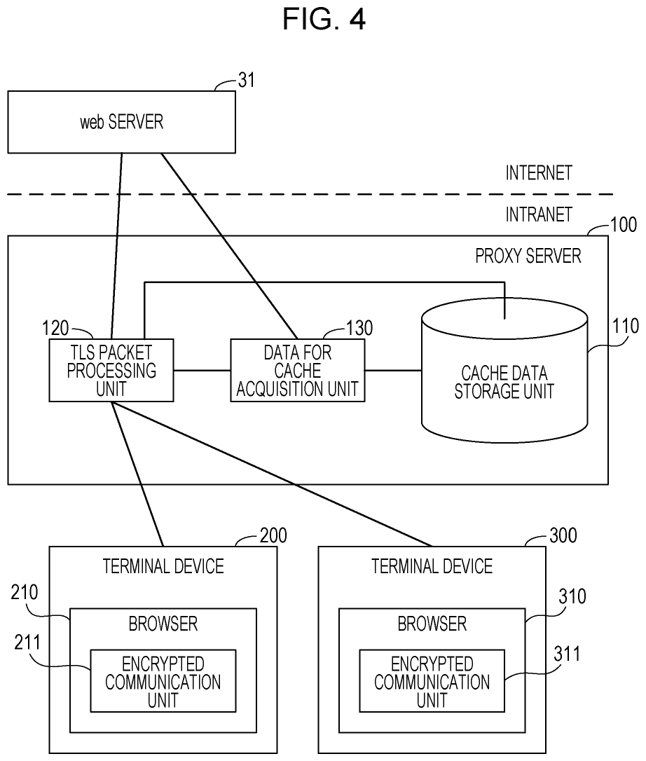

FIG. 4 is a block diagram illustrating a function for implementing the encrypted communication with the cache. The example of FIG. 4 assumes that browser 210 or 310 within the terminal device 200 or 300 acquire data items through the encrypted communication from the Web server 31.

The terminal devices 200 and 300 have the browsers 210 and 310, respectively. The browsers 210 and 310 include encrypted communication units 211 and 311, respectively. The browser 210 or 310 is able to perform the encrypted communication with the Web server 31 by HTTPS by using the encrypted communication unit 211 or 311. In HTTPs, Transport Layer Security (TLS) is used as a protocol of the encrypted communication. When the data acquisition request is transmitted to the Web server 31 through the encrypted communication, the encrypted communication unit 211 or 311 gives the identifier (URL) of the plaintext of the data to be acquired to a transmission packet.

The proxy server 100 includes a cache data storage unit 110, a TLS packet processing unit 120, and a data for cache acquisition unit 130. The cache data storage unit 110 stores the cache data of the plaintext. For example, a part of a storage region of the storage device 103 or the memory 102 of the proxy server 100 is used as the cache data storage unit 110.

The TLS packet processing unit 120 performs relay processing of a packet for data communication encrypted by TLS. For example, when the packet including the data acquisition request is received from any of the terminal devices 200 and 300, the TLS packet processing unit 120 extracts the URL of the plaintext indicating a position of the data to be acquired from the packet. The TLS packet processing unit 120 determines whether or not there is the cache data corresponding to the data to be acquired based on the extracted URL. When there is the cache data corresponding to the data to be acquired, the TLS packet processing unit 120 reads out the corresponding cache data from the cache data storage unit 110, and transmits the cache data to the terminal device. When there is no cache data corresponding to the data to be acquired, the TLS packet processing unit 120 deletes the URL of the plaintext of the data to be acquired from the received packet, and transmits the packet in which the URL is deleted to the Web server 31. When there is no cache data corresponding to the data to be acquired, the TLS packet processing unit 120 transmits a cache request for instructing the data for cache acquisition unit 130 to cache the corresponding data.

The data for cache acquisition unit 130 acquires data from the Web server 31 according to the cache request. The data for cache acquisition unit 130 stores, as the cache data, the acquired data in association with a URL of an acquisition source of the data in the cache data storage unit 110. The data for cache acquisition unit 130 performs processing in a thread different from the TLS packet processing unit 120. The data for cache acquisition unit 130 performs cache processing of the data corresponding to the cache request at any timing. For example, the functions of the elements illustrated in FIG. 4 are able to be implemented by causing a computer to execute program modules corresponding to the elements.

Next, the cache data stored in the cache data storage unit 110 will be described in detail.

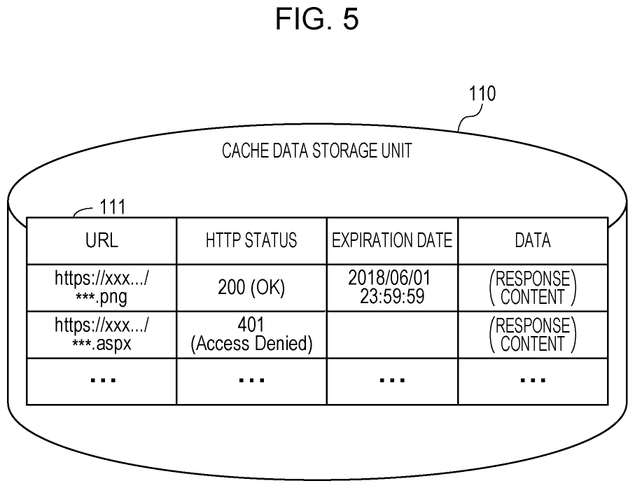

FIG. 5 is a diagram illustrating an example of data within the cache data storage unit. For example, the cache data storage unit 110 stores a cache data management table 111 for recording a record for each cache data. Columns of URL, HTTP status, expiration date, and data item are prepared in the cache data management table 111.

A URL indicating the position of the acquisition source of the cache data and the name of the data is set in the column of the URL. A status code of a response using HTTP when the position indicated by the URL is designated and the data acquisition request is transmitted to the Web server 31 is set in the column of the HTTP status. For example, a status code of a response including the requested data to the request for requesting the acquisition of the data is “200”. The data requested by the data acquisition request is data to be transmitted to only an authenticated user and the data acquisition request is transmitted with no authentication, a status code of the response is “401”.

An expiration date for using, as the cache data, the data acquired from the Web server 31 is set in the column of the expiration date. The expiration date is set when the data of the designated URL is correctly acquired.

The data transmitted from the Web server 31 in response to the data acquisition request is set in the column of the data. For example, in a case where the HTTP status of the response is “200”, the data of the position designated by the URL is set in the column of the data. For example, in a case where the HTTP status of the response is “401”, an error message indicated by the response is set in the column of the data.

In the system having the configuration described above, the terminal device 200 or 300 gives the URL of the data to be acquired to the packet to be transmitted to the Web server 31 separately from the data to be sent to the Web server 31 in order to enable the caching of the data in the proxy server 100. For example, the terminal device 200 or 300 is able to add a record of the plaintext (record for cache) including the URL of the data to a packet for the encrypted communication using TLS.

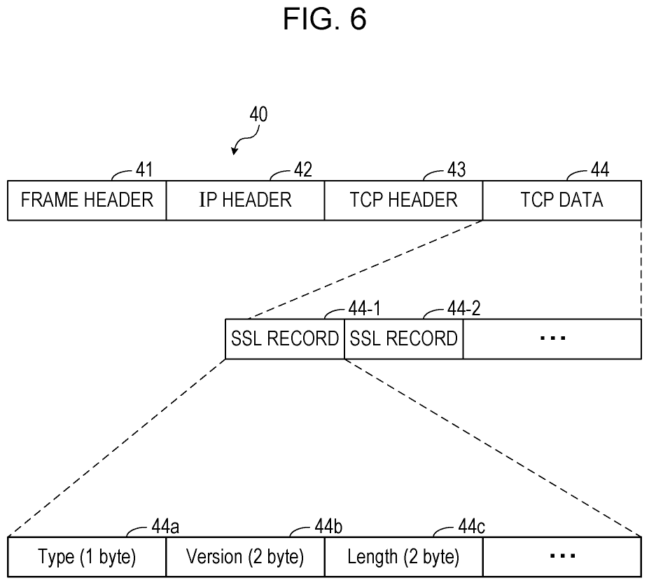

FIG. 6 is a diagram illustrating an example of a packet format for the encrypted communication. For example, in the case of a packet 40 of the Transmission Control Protocol (TCP), a frame header 41, an Internet Protocol (IP) header 42, a TCP header 43, and TCP data 44 are included in the packet 40. The frame header 41 is information for performing communication by a protocol of a data link layer such as Ethernet (registered trademark). The IP header 42 is information for performing communication by the IP. A transmission source IP address and a destination IP address is included in the IP header 42. The TCP header 43 is information for performing communication by TCP. The TCP data 44 is data delivered to a transmission destination of the packet. For example, when the terminal device 200 or 300 acquires data from the Web server 31, the URL of the data to be acquired is indicated within the TCP data 44. When the data is transmitted from the Web server 31 to the terminal device 200 or 300, the requested data is written within the TCP data 44.

The proxy server 100 is able to refer to information items of the frame header 41, the IP header 42, and the TCP header 43 of the packet 40. In this example, when the terminal device 200 or 300 and the Web server 31 do not perform the encrypted communication and perform the communication by HTTP, the proxy server 100 is also able to refer to TCP data. Thus, in the case of the HTTP communication, the proxy server 100 acquires the URL of the data for the Web server 31 from the packet of the request from the terminal device 200 or 300. The proxy server 100 is able to acquire data corresponding to the URL by transmitting the request that designates the acquired URL. Accordingly, it is possible to cache the URL and the data in association with each other in the proxy server 100.

Meanwhile, when the encrypted communication is performed between the terminal device 200 or 300 and the Web server 31 by HTTPs, the TCP data 44 is encrypted. Specifically, a plurality of SSL records 44-1, 44-2, . . . is included in the TCP data 44 of the HTTP communication, and some types of SSL records are encrypted.

A type (Type) 44a, a version (Version) 44b, a data length (Length) 44c are set in first five bytes of each of the SSL records 44-1, 44-2, . . . . The type of the SSL record is indicated in one byte of the type 44a, and the following four types are defined in TLS. [20, 0x14]: change_cipher_spec, [21, 0x15]: alert, [22, 0x16]: handshake, [23, 0x17]: application_data.

A first number of a value indicating the type is an identification number of the type in the decimal system, and the next value represents the identification number in the hexadecimal system. The SSL record of the type of “Application Data” is encrypted. Another type of SSL record is not encrypted. The proxy server 100 is not able to refer to the content of the encrypted SSL record.

In the packet of TLS to be transmitted to the Web server 31 from the terminal device 200 or 300, the data acquisition request for the Web server 31 is added to the SSL record of the type of “Application Data”. Thus, the URL of the data indicated by the data acquisition request is encrypted.

The proxy server 100 is not able to refer to the content of the encrypted SSL record, but the SSL record structure of the TCP data 44 is able to be recognized. Thus, when the request of HTTPS for the Web server 31 is transmitted, the encrypted communication unit 211 or 311 of the terminal device 200 or 300 adds the record for cache including information to be notified to the proxy server 100 behind the SSL record. The encrypted communication unit 211 or 311 does not encrypt the record for cache. For example, the encrypted communication unit 211 or 311 sets, as the value of the type in the same format as the SSL record, a value [24, 0x18] (“24” in the decimal system and “18” in the hexadecimal system) indicating the record for cache in order to distinguish the record for cache from the SSL record. The value [24, 0x18] indicating the record for cache is an example, and the encrypted communication unit 211 or 311 is able to set, as the value indicating the record for cache, another undefined value in the SSL protocol, such as [25, 0x19].

The information to be notified to the proxy server 100 is the URL of the data to be acquired from the Web server 31. Information such as POST data and cookies is not included in the information to be notified. Since the POST data and the cookies are likely to include authentication information and personal information, these data items are not added to the record for cache, and thus, unencrypted authentication information and personal information are able to be restrained from being communicated.

When the URL of the data requested by the request is recognized by referring to the record for cache and the cache data corresponding to the URL is stored in the cache data storage unit 110, the proxy server 100 transmits the cache data as a response. The cache data as the type [24, 0x18] is added to the TCP data 44 of the packet of the response.

When there is no cache data corresponding to the URL of the data requested by the request, the proxy server 100 deletes the record for cache from the packet of the request, and transmits the request in which the record for cache is deleted to the Web server 31. Thereafter, the proxy server 100 is separately coupled to the Web server 31, acquires the data corresponding to the URL from the terminal device 200 or 300 from the Web server 31, and caches the data.

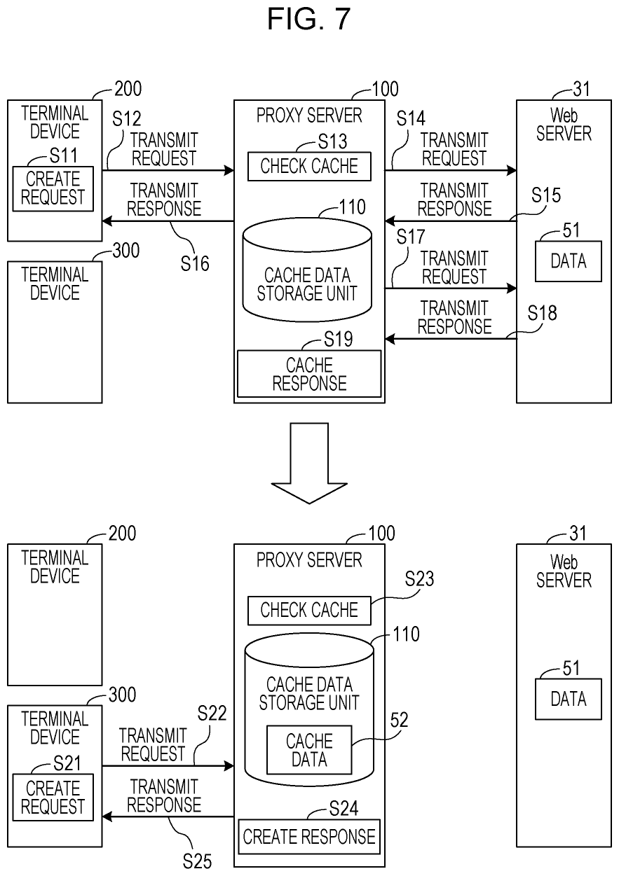

FIG. 7 is a diagram illustrating an outline of the data caching in the proxy server. An example of a case where a data acquisition request for the same data 51 is transmitted by another terminal device 300 after data 51 owned by the Web server 31 is acquired by the terminal device 200 is illustrated in FIG. 7. It is assumed that the terminal device 200 or 300 and the Web server 31 perform the encrypted communication using HTTPS.

Initially, in the terminal device 200, the encrypted communication unit 211 creates the acquisition request for the data 51 (step S11). On this occasion, the encrypted communication unit 211 adds the URL to be notified to the proxy server 100 without encrypting the URL subsequently the SSL record within the request. For example, information of [0x18, 0x0000, 0x001f, https://www.abc.com/picture.png] is added behind the SSL record. “0x001f” (“31” in the decimal system) within the added information is a length (number of bytes) of a character string of “https:// . . . ” of described in the subsequent URL. The encrypted communication unit 211 transmits the request addressed to the Web server 31 to the proxy server 100 (step S12).

In the proxy server 100, the TLS packet processing unit 120 checks whether or not the cache data corresponding to the URL added behind the SSL record in the request is present within the cache data storage unit 110 (step S13). At this point, since there is no cache data, the TLS packet processing unit 120 deletes the URL added behind the SSL record from the request received from the terminal device 200, and transmits the request in which the URL is deleted to the Web server 31 (step S14).

The Web server 31 transmits a response including the data 51 to the proxy server 100 according to the request (step S15). The TLS packet processing unit 120 of the proxy server 100 transmits the response from the Web server 31 to the terminal device 200 (step S16).

The TLS packet processing unit 120 that checks that there is no cache data designates the URL included in the received request, and transmits the cache request of the data 51 to the data for cache acquisition unit 130. By doing this, the data for cache acquisition unit 130 transmits the request for requesting the acquisition of the data 51 to the Web server 31 through the encrypted communication using HTTPS (step S17). When the request is received, the Web server 31 transmits the response including the encrypted data 51 to the proxy server 100 (step S18).

The data for cache acquisition unit 130 of the proxy server 100 decrypts the data 51 included in the received response, and caches the data (step S19). Accordingly, cache data 52 corresponding to the data 51 owned by the Web server 31 is stored in the cache data storage unit 110.

Thereafter, the encrypted communication unit 311 of the terminal device 300 creates the acquisition request for the data 51 (step S21). At this time, similarly to the encrypted communication unit 211, the encrypted communication unit 311 adds the URL to be notified to the proxy server 100 without encrypting the URL subsequently the SSL record within the request. The encrypted communication unit 311 transmits the request addressed to the Web server 31 to the proxy server 100 (step S22). In the proxy server 100, the TLS packet processing unit 120 checks whether or not the cache data 52 corresponding to the URL added behind the SSL record in the request is present within the cache data storage unit 110 (step S23). At this time, since there is the cache data 52, the TLS packet processing unit 120 creates the response including the cache data 52 (step S24). The TLS packet processing unit 120 transmits the response to the terminal device 300 (step S25).

The data 51 acquired by the terminal device 200 from the Web server 31 in this manner is able to be cached in the proxy server 100. Thereafter, when the request for the same data 51 is output from the terminal device 300, the proxy server 100 is able to increase efficiencies of processing by transmitting the cache data 52 to the terminal device 300.

The communication between the terminal device 200 and the Web server 31 is encrypted, and the data 51 included in the response of the Web server 31 in step S15 is also encrypted. Thus, in the proxy server 100, the data 51 is not able to be acquired from the response transmitted in step S15. Thus, in the proxy server 100, the data for cache acquisition unit 130 acquires the data 51 from the Web server 31 by performing the encrypted communication with the Web server 31.

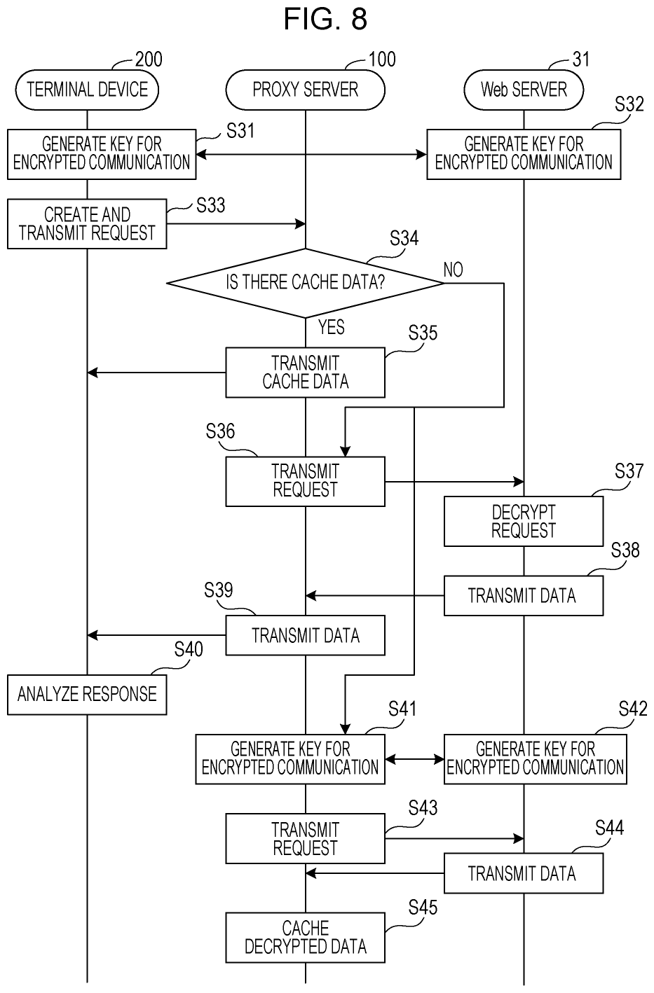

Hereinafter, a processing procedure of the communication including data caching in the proxy server 100 will be described with reference to FIG. 8. FIG. 8 is a sequence diagram illustrating the processing procedure of the communication including the data caching. The encrypted communication unit 211 of the terminal device 200 and the Web server 31 generate the keys for the encrypted communication while cooperating with each other (steps S31 and S32). For example, the encrypted communication unit 211 and the Web server 31 generate a shared key according to the specification of TLS. The terminal device 200 encrypts the sixth and subsequent bytes of the SSL record with the key created in step S31, creates the request encrypted with the TCP data, and transmits the request to the proxy server 100 (step S33). The URL of the data to be acquired is set in the request by the plaintext behind the SSL record.

In the proxy server 100, the TLS packet processing unit 120 determines whether or not the cache data corresponding to the URL indicated by the plaintext is present in the request (step S34). When there is the corresponding cache data, the TLS packet processing unit 120 transmits the response including the cache data to the terminal device 200 (step S35). For example, the TLS packet processing unit 120 sets, as the type of the data, the value [24, 0x18] indicating the cache data is the data of the plaintext to the packet of the response of the cache data.

When there is no cache data, the TLS packet processing unit 120 deletes the URL of the plaintext from the request received from the terminal device 200, and transmits the request in which the URL is deleted to the Web server 31 (step S36). The Web server 31 decrypts the request with the key generated in step S32 (step S37). The Web server 31 encrypts data corresponding to the URL indicated by the decrypted request with the key generated in step S32, and transmits the response including the encrypted data to the proxy server 100 (step S38). In the proxy server 100, the TLS packet processing unit 120 receives the response, and transmits the received response to the terminal device 200 (step S39). Vertical lines in FIG. 8 do not necessarily mean transition between processing steps, and may simply indicate which device (terminal device 200, proxy server 100, and Web server 31) the processing step corresponds to.

The encrypted communication unit 211 of the terminal device 200 analyzes the response from the proxy server 100 (step S40). For example, the encrypted communication unit 211 refers to the type of the record included in the TCP data within the packet of the response, and determines whether or not the data within the record is the cache data of the plaintext when the type is [24, 0x18]. For example, when the type is [23, 0x17], the encrypted communication unit 211 determines that the data within the record is the encrypted data. When the encrypted data is received, the encrypted communication unit 211 decrypts the data with the key generated in step S31.

When there is no cache data, the data for cache acquisition unit 130 and the Web server 31 cooperate with each other, and generate the keys for the encrypted communication (steps S41 and S42). For example, the data for cache acquisition unit 130 and the Web server 31 generate the shared key according to the specification of TLS. The data for cache acquisition unit 130 transmits the request which includes the URL indicated by the plaintext in the request transmitted by the terminal device 200, which is encrypted with the key created in step S41, to the Web server 31 (step S43). The Web server 31 decrypts the request with the key generated in step S42. The Web server 31 encrypts the data corresponding to the URL indicated by the request with the key generated in step S42, and transmits the response including the encrypted data to the proxy server 100 (step S44). The proxy server 100 decrypts the data included in the response with the key generated in step S41, and caches the data in the cache data storage unit 110 (step S45).

Next, a procedure processing performed in the browser 210, the TLS packet processing unit 120, and the data for cache acquisition unit 130 will be described in detail.

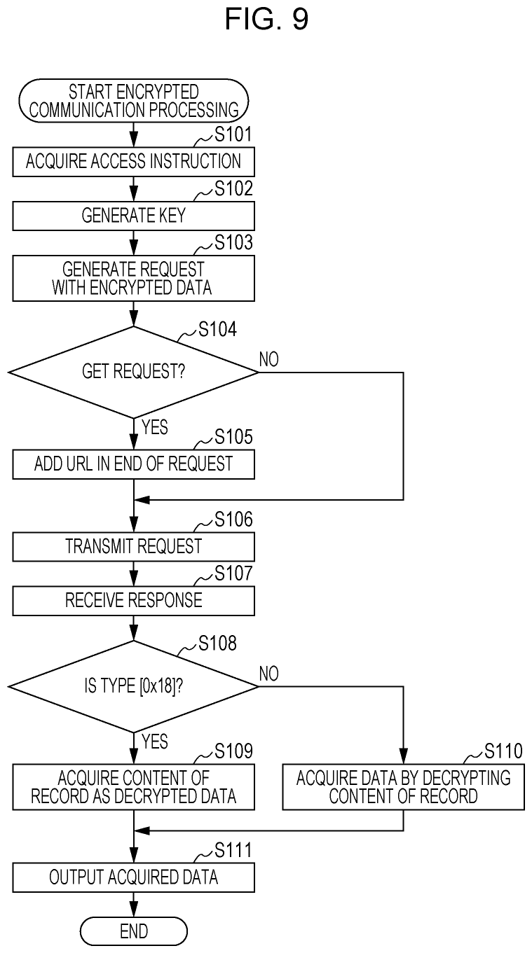

FIG. 9 is a flowchart illustrating an example of a procedure of encrypted communication processing in the browser. The processing illustrated in FIG. 9 will be described below according to step numbers.

[Step S101] The browser 210 generates a request according to an access command for the Web server 31. For example, the browser 210 acquires, as the access command, an input of the URL or an input of a selection of favorites (bookmark) or a selection of a link of HTML data displayed on the screen, which is performed by the user. The browser 210 acquires, as the access command, an event of access to the Web server 31 occurring in a procedure for executing a program.

In this example, when the access by HTTPS is designated in the access request, the browser 210 starts the encrypted communication using the encrypted communication unit 211. When the browser 210 accesses to the Web server 31 according to the access request, and starts the encrypted communication using the encrypted communication unit 211 when re-access by HTTPS is requested from the Web server 31. Processing when the encrypted communication is performed will be described below.

[Step S102] The encrypted communication unit 211 generates the key to be used for encryption and decryption in cooperation with the Web server 31.

[Step S103] The encrypted communication unit 211 generates a request acquired by encrypting the data with the generated key. For example, the encrypted communication unit 211 encrypts the sixth and subsequent bytes of an SSL record including a URL of an access destination.

[Step S104] The encrypted communication unit 211 determines whether or not the content of the request is a GET request indicating data acquisition. When the content of the request is the GET request, the encrypted communication unit 211 advances the processing to step S105. When the content of the request is a request other than the GET request, the encrypted communication unit 211 advances the processing to step S106. Examples of the request other than the GET request include “POST/PUT/DELETE” requests.

[Step S105] The encrypted communication unit 211 adds the record for cache including the URL of the access destination as the plaintext at the end of the request. The encrypted communication unit 211 sets a value of the type of the added SSL record as [0x18]. The cookies and the authentication information are not included in the record for cache to be added.

[Step S106] The encrypted communication unit 211 transmits the request for the Web server 31 to the proxy server 100. Thereafter, the encrypted communication unit 211 waits for the response from the proxy server 100.

[Step S107] The encrypted communication unit 211 receives the response from the proxy server 100.

[Step S108] The encrypted communication unit 211 determines whether or not the record of which the value of the type is [0x18] is present in the record within the response. When the record is present, the encrypted communication unit 211 advances the processing to step S109. When the record is not present, the encrypted communication unit 211 advances the processing to step S110.

[Step S109] The encrypted communication unit 211 acquires, as the decrypted data, the data included in the record of which the type is [0x18]. Thereafter, the encrypted communication unit 211 advances the processing to step S111.

[Step S110] The encrypted communication unit 211 decrypts the content of the SSL record within the response, and acquires the data of the plaintext.

[Step S111] The encrypted communication unit 211 outputs the acquired data. For example, the data output by the encrypted communication unit 211 is displayed on a monitor of the terminal device 200 by the browser 210.

By doing this, in the terminal device 200, even when the cache data of the plaintext is included in the response to the request transmitted to the Web server 31 through the encrypted communication, the cache data is able to be acquired as the data requested by the request.

In step S104 of FIG. 9, the type of the request is determined. The type of the request is able to be determined by referring to the top line of the request.

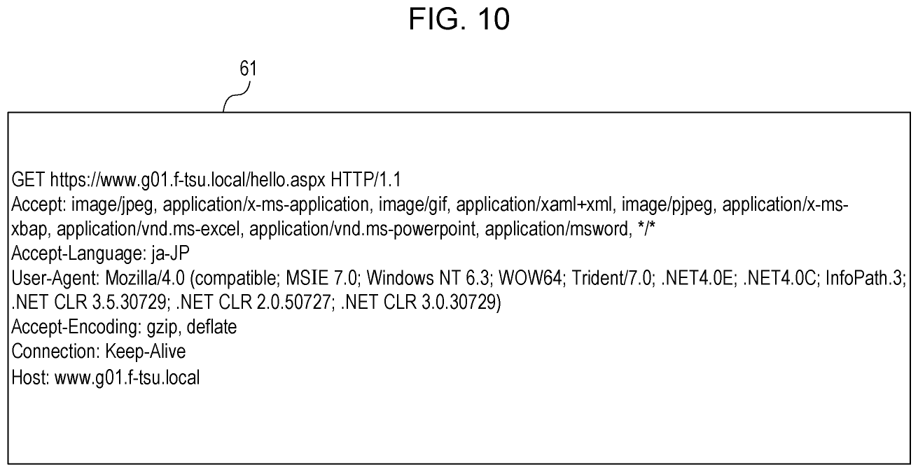

FIG. 10 is a diagram illustrating an example of the request of the GET request. Since “GET https://www.g01.f-tsu.local/hello.aspx HTTP/1.1” is described in the top line, it is understood that a request 61 illustrated in FIG. 10 is the GET request.

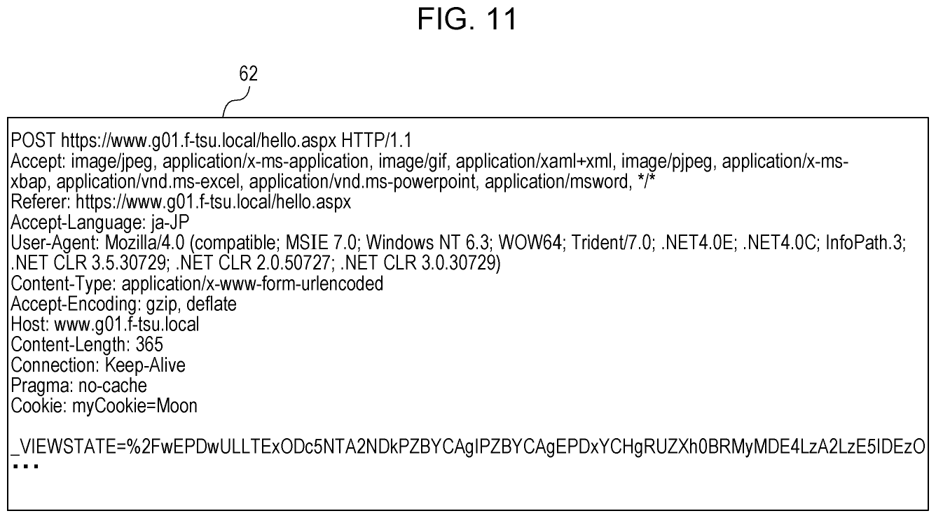

FIG. 11 is a diagram illustrating an example of the request of the POST request. Since “POST https://www.g01.f-tsu.local/hello.aspx HTTP/1.1” is described in the top line, it is understood that a request 62 illustrated in FIG. 11 is the POST request.

When the request 61 is the GET request as illustrated in FIG. 10, the encrypted communication unit 211 adds the record for cache indicating URL information to the end of the request 61.

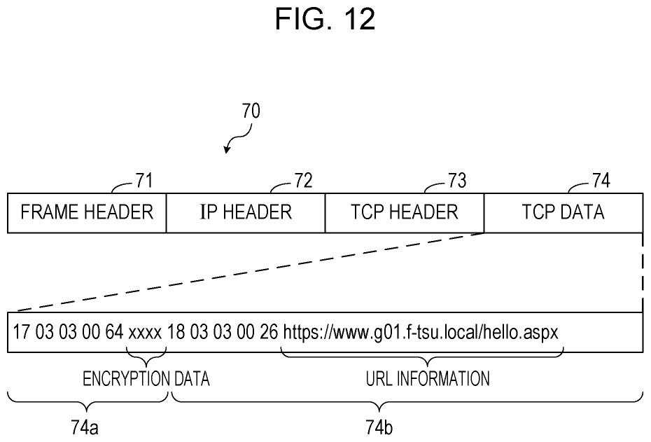

FIG. 12 is a diagram illustrating an example of the packet of the request including the URL information. A frame header 71, an IP header 72, a TCP header 73, and TCP data 74 are included in a packet 70. In the TCP data 74, a record for cache 74b is added behind an SSL record 74a.

The first five bytes of the SSL record 74a are “17 03 03 00 64”. The first byte indicates that a type is [0x17] (application_data). The second and third bytes indicate that versions are “03 03”. The fourth and fifth bytes indicate that data lengths are “00 64” (100 bytes in the decimal system). “xxxx” in the sixth and subsequent bytes indicates 100 bytes of encrypted data.

The first five bytes of the record for cache 74b are “18 03 03 00 26”. The first byte indicates that a type is [0x18] (URL information). The second and third bytes indicate that versions are “03 03”. The fourth and fifth bytes indicate that data lengths are “00 26” (38 bytes in the decimal system). “https://www.g01.f-tsu.local/hello.aspx” in the sixth and subsequent bytes is URL information.

Although the URL information is represented by a character string in FIG. 12, character codes “68 74 74 70 73 3a 2f 2f . . . ” corresponding to characters are actually set within the packet 70.

There are some cases where a search query of “?query=PCserver” is added to the end of the URL in a search request of a Web page. For example, “GET https://www.f-tsu.com/jp/search/?query=PCserver HTTP/1.1” is described in the top line of the request. In this case, the encrypted communication unit 211 sets a URL “https://www.f-tsu.com/jp/search/?query=PCserver” including the query as the data within the record for cache.

Next, packet relay processing performed by the TLS packet processing unit 120 that receives the request from the terminal device 200 will be described in detail.

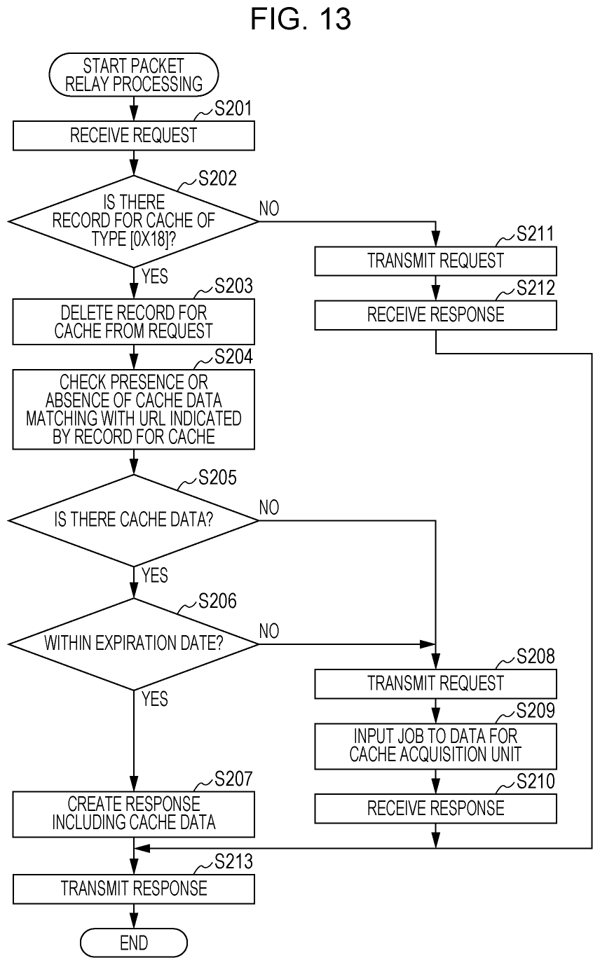

FIG. 13 is a flowchart illustrating an example of a procedure of the packet relay processing performed by the TLS packet processing unit. The processing illustrated in FIG. 13 will be described below according to step numbers.

[Step S201] The TLS packet processing unit 120 receives the request from the terminal device 200.

[Step S202] The TLS packet processing unit 120 determines whether or not the record for cache of which the type is [0x18] is present in the received request. When the record for cache is present, the TLS packet processing unit 120 advances the processing to step S203. When the record for cache is not present, the TLS packet processing unit 120 advances the processing to step S211.

[Step S203] The TLS packet processing unit 120 stores the record for cache in the memory 102, and then deletes the record for cache from the received request.

[Step S204] The TLS packet processing unit 120 checks whether or not there is the cache data matching the URL indicated by the record for cache. For example, the TLS packet processing unit 120 searches for the URL indicated by the record for cache from the column of the URL of the cache data management table 111 within the cache data storage unit 110. When the matching URL is found, the TLS packet processing unit 120 checks the HTTP status corresponding to the corresponding URL. When the HTTP status is “200 (OK)”, the TLS packet processing unit 120 determines that there is the cache data corresponding to the URL indicated by the record for cache.

[Step S205] When there is the cache data corresponding to the URL indicated by the record for cache, the TLS packet processing unit 120 advances the processing to step S206. When there is no cache data corresponding to the URL indicated by the record for cache, the TLS packet processing unit 120 advances the processing to step S208.

[Step S206] The TLS packet processing unit 120 determines whether or not a current date and time is within the expiration date of the cache data. For example, the TLS packet processing unit 120 acquires the expiration date corresponding to the URL indicated by the record for cache from the cache data management table 111. When the current date and time is before the expiration date, the TLS packet processing unit 120 determines that the current date and time is within the expiration date. When the current date and time is within the expiration date, the TLS packet processing unit 120 advances the processing to step S207. When the current date and time exceeds the expiration date, the TLS packet processing unit 120 advances the processing to step S208.

[Step S207] The TLS packet processing unit 120 creates the response including, as the record for cache of which the type is [0x18], the cache data. Thereafter, the TLS packet processing unit 120 advances the processing to step S213.

[Step S208] The TLS packet processing unit 120 transmits the request received from the terminal device 200 to the Web server 31.

[Step S209] The TLS packet processing unit 120 inputs a job for requesting the caching of the data corresponding to the URL indicated by the received request to the data for cache acquisition unit 130.

[Step S210] The TLS packet processing unit 120 receives the response from the Web server 31. Thereafter, the TLS packet processing unit 120 advances the processing to step S213.

[Step S211] The TLS packet processing unit 120 transmits the request received from the terminal device 200 to the Web server 31.

[Step S212] The TLS packet processing unit 120 receives the response from the Web server 31.

[Step S213] The TLS packet processing unit 120 transmits the response to the terminal device 200.

The TLS packet processing unit 120 determines whether or not there is the cache data in this manner, and is able to transmit the cache data, as a response, without transmitting the request to the Web server 31 when there is valid cache data.

When there is no valid cache data, the TLS packet processing unit 120 requests the data for cache acquisition unit 130 to cache the data by inputting the job of the cache request to the data for cache acquisition unit 130. The data for cache acquisition unit 130 acquires the cache data according to the input job.

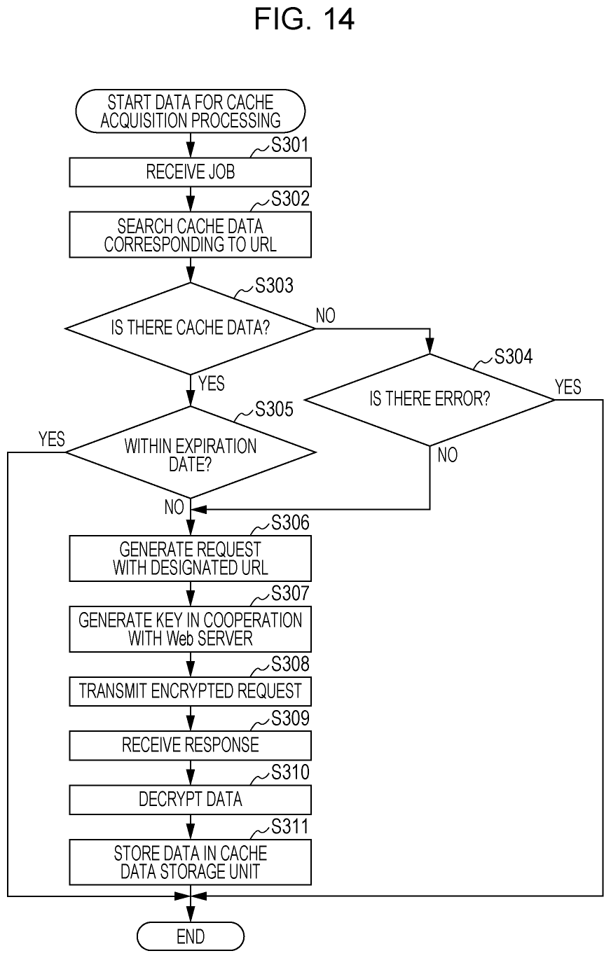

FIG. 14 is a flowchart illustrating an example of a procedure for data for cache acquisition processing. The processing illustrated in FIG. 14 will be described below according to step numbers.

[Step S301] The data for cache acquisition unit 130 receives the job from the TLS packet processing unit 120. For example, the data for cache acquisition unit 130 stores the received job in a queue.

[Step S302] The data for cache acquisition unit 130 searches for the cache data corresponding to the URL indicated by the received job from the cache data storage unit 110.

The data for cache acquisition unit 130 may perform the processing subsequent to step S302 immediately after the job is received, or may perform the processing after waiting for a predetermined timing. For example, the data for cache acquisition unit 130 may perform the processing subsequent to step S302 when a load of the proxy server 100 is equal to or less than a predetermined value.

[Step S303] The data for cache acquisition unit 130 determines whether or not the cache data is detected. When the cache data is detected, the data for cache acquisition unit 130 advances the processing to step S305. When the cache data is detected, the data for cache acquisition unit 130 advances the processing to step S304.

[Step S304] The data for cache acquisition unit 130 determines whether or not an error occurs in the past data acquisition from the URL indicated by the received job. For example, when the value of the HTTP status corresponding to the URL indicated by the received job is a value indicating the error (other than “200”) in the cache data management table 111, the data for cache acquisition unit 130 determines that the error occurs. When the error occurs, the data for cache acquisition unit 130 ends the data for cache acquisition processing. When the error does not occur, the data for cache acquisition unit 130 advances the processing to step S306.

[Step S305] The data for cache acquisition unit 130 determines whether or not the current date and time is within the expiration date of the cache data. For example, the data for cache acquisition unit 130 acquires the expiration date corresponding to the URL indicated by the received job in the cache data management table 111. When the current date and time is before the expiration date, the data for cache acquisition unit 130 determines that the current date and time is within the expiration date. When the current date and time is within the expiration date, the data for cache acquisition unit 130 ends the data for cache acquisition processing. When the current date and time exceeds the expiration date, the data for cache acquisition unit 130 advances the processing to step S306.

[Step S306] The data for cache acquisition unit 130 generates the request of the GET request that designates the URL indicated by the job.

[Step S307] The data for cache acquisition unit 130 generates the key for the encrypted communication in cooperation with the Web server 31.

[Step S308] The data for cache acquisition unit 130 transmits the request to the Web server 31 through the encrypted communication.

[Step S309] The data for cache acquisition unit 130 receives the response from the Web server 31.

[Step S310] The data for cache acquisition unit 130 decrypts the data included in the received response.

[Step S311] The data for cache acquisition unit 130 stores the decrypted data in the cache data storage unit 110. There are some cases where a response of the error to the request is returned from the Web server 31. For example, when data as an acquisition target is data that is not able to be acquired without authentication from the user or is data that is not able to be acquired without cookies, the response of the error is returned. When the response is the error, the data for cache acquisition unit 130 stores information indicating the error content in the cache data storage unit 110.

For example, the data for cache acquisition unit 130 adds a new record including the acquired data to the cache data management table 111 within the cache data storage unit 110. The data for cache acquisition unit 130 sets a URL of an acquisition source of the acquired data in the column of the URL of the added record. The data for cache acquisition unit 130 sets the status of the response in the column of the HTTP status of the added record. The data for cache acquisition unit 130 sets the expiration date designated within the response from the Web server 31 in the column of the expiration date of the added record. When the expiration date is not designated in the response, the data for cache acquisition unit 130 sets a preset default value of the expiration date in the column of the expiration date of the added record.

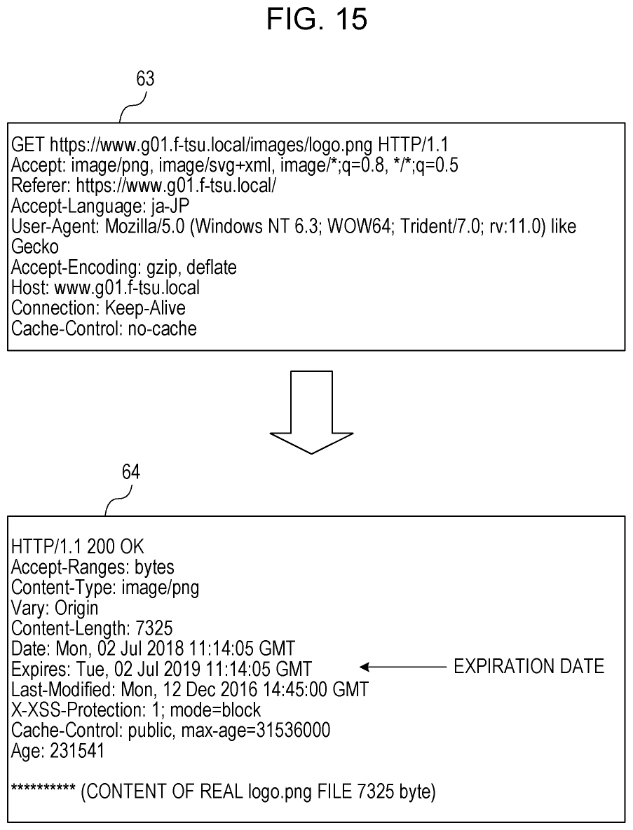

FIG. 15 is a diagram illustrating an example of the response with the expiration date of the data. Although a request 63 is encrypted and the request is transmitted to the Web server 31 in the example of FIG. 15, a response 64 is returned from the Web server 31. The expiration date is designated in the response 64 by description of “Expires: Tue, 2 Jul. 2019 11:14:05 GMT”. In the example of FIG. 15, a date and time one year after the current date and time indicated by “Date” is designated as the expiration date. The data for cache acquisition unit 130 sets, as the expiration date of the data included in the response 64, the date and time indicated by “Expires” of the response 64 in the cache data management table 111.

The expiration date of the data is also able to be designated in the response 64. For example, the expiration date is able to be designated in seconds in a value of “max-age” of “Cache-Control” of the response 64. In the example of FIG. 15, the expiration date is 31536000 seconds which is a period corresponding to 365 days.

It is possible to designate whether or not to permit caching in the proxy server 100 in the response 64. For example, when “public” is designated in “Cache-Control” of the response 64, the proxy server 100 is able to cache the data within the response 64. Meanwhile, when “private” is designated in “Cache-Control” of the response 64, since the content of the response 64 is user specific information, the proxy server 100 is not able to cache the data within the response 64. When “private” is designated in “Cache-Control” of the response 64, the browser 210 of the terminal device 200 is able to cache the data within the response 64.

The response 64 is able to be data cached by any device. In this case, an elapsed time after the data is initially cached is set as a value of “Age” of the response 64 in seconds. In the example of FIG. 15, the cache is already cached for 231541 seconds.

The data acquired by the proxy server 100 is used as the cache data within the expiration date. When the request of the GET request that designates the URL corresponding to the cache data is output from the terminal device 200 within the intranet 33, the TLS packet processing unit 120 of the proxy server 100 transmits the cache data of the plaintext to the terminal device 200.

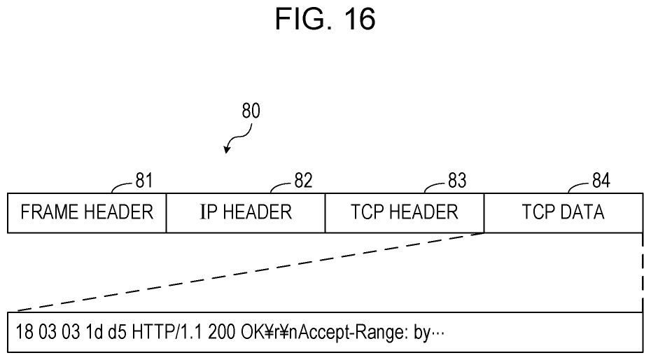

FIG. 16 is a diagram illustrating an example of a packet for transmitting the cache data as a response. In FIG. 16, a packet 80 for transmitting, as the cache data, the data acquired by the response illustrating in FIG. 15 is illustrated. A frame header 81, an IP header 82, a TCP header 83, and a TCP data 84 are included in the packet 80.

The first five bytes of the TCP data 84 are “18 03 03 1d d5”. The first byte indicates that a type is [0x18] (record for cache). The second and third bytes indicate that versions are “03 03”. The fourth and fifth bytes indicate that data lengths of the response contents are “1d d5” (7637 bytes in the decimal system). The cache data of the plaintext is described as the content of the response in the sixth and subsequent bytes.

Although the content of the response is represented by a character string in FIG. 16, character codes “48 54 54 50 2f 31 2e 31 . . . ” corresponding to the characters are actually set within the packet 80. “ [symbol] r [symbol] n” indicated in the content of the response is an escape sequence of a character code representing a new line. In actuality, “ [symbol] r” is “0d” which is one byte, and “ [symbol] n” is “0a” which is one byte.

As described, in the second embodiment, the data acquired from the Web server 31 by one terminal device within the intranet 33 is able to be cached as the plaintext in the proxy server 100 through the encrypted communication. Accordingly, when the other terminal device outputs the request for the acquisition of the same data, the proxy server 100 is able to transmit the cache data as the response to this terminal device. As a result, it is possible to improve efficiency in the data acquisition processing through the encrypted communication.

### OTHER EMBODIMENTS

Although the example of the encrypted communication by TLS has been described in the second embodiment, it is possible to cache the data in the proxy server 100 even through another encrypted communication as in the second embodiment.

The browsers 210 and 310 of the terminal devices 200 and 300 include the encrypted communication units 211 and 311, respectively. However, the units of the terminal devices 200 and 300 that perform the encrypted communication with the Web server 31 are not limited to the browsers 210 and 310. Software other than the browsers 210 and 310 is able to perform the same encrypted communication processing as that of FIG. 9 by using the same functions of the encrypted communication units 211 and 311. That is, software other than the browsers 210 and 310 is able to cause the proxy server 100 to cache the data as an encrypted communication target or is able to acquire the cache data of the data communicated through the encrypted communication from the proxy server 100.

Although the embodiments have been described, the configurations of the units described in the embodiments are able to be replaced with other units having the same functions. Any other constituents or processes may be added. Any two or more configurations (features) of the aforementioned embodiments may be combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a cache control program causing a computer to execute:
determining, when a first request which includes an encrypted data acquisition request for requesting acquisition of data within a server and an identifier in plaintext of the data and is addressed to the server is received, whether or not cache data corresponding to the identifier is stored in a storage of the computer;
transmitting, when the cache data is stored in the storage, to a transmission source of the first request, a first response including the cache data;
transmitting, when the cache data is not stored in the storage, to the server, a second request acquired by deleting the identifier from the first request and transmitting, to the server, a third request for requesting the acquisition of the data;
transmitting, when a second response to the second request is received from the server, to the transmission source of the first request, the second response; and
storing, when a third response to the third request is received from the server, as the cache data, the data included in the third response in association with the identifier in the storage.

2. The non-transitory computer-readable recording medium according to claim 1,
wherein the second response is encrypted with a first key used for encrypting the data acquisition request, and
the third request and the third response are encrypted with a second key different from the first key, and the data included in the third response is decrypted and stored in the storage.

3. The non-transitory computer-readable recording medium according to claim 1,
wherein, during the transmission of the third request, the third request is transmitted through encrypted communication, and
during the reception of the third response, the third response is received through encrypted communication, the encrypted data included in the third response is decrypted, and the decrypted data is stored in association with the identifier in the storage.

4. The non-transitory computer-readable recording medium according to claim 1,
wherein, during the transmission of the first response, information indicating that the cache data within the first response is in plaintext is added to the first response.

5. A cache method, performed by a computer, comprising:
determining, when a first request which includes an encrypted data acquisition request for requesting acquisition of data within a server and an identifier in plaintext of the data and is addressed to the server is received, whether or not cache data corresponding the identifier is stored in a storage of the computer;
transmitting, when the cache data is stored in the storage, to a transmission source of the first request, a first response including the cache data;
transmitting, when the cache data is not stored in the storage, to the server, a second request acquired by deleting the identifier from the first request and transmitting, to the server, a third request for requesting the acquisition of the data;
transmitting, when a second response to the second request is received from the server, to the transmission source of the first request, the second response; and
storing, when a third response to the third request is received from the server, as the cache data, the data included in the third response in association with the identifier in the storage.

6. A proxy server comprising:
a storage storing cache data in association with an identifier of the cache data; and
a processor coupled to the storage and configured to:
determine, when a first request which includes an encrypted data acquisition request for requesting acquisition of data within a server and the identifier in plaintext of the data and is addressed to the server is received, whether or not the cache data corresponding to the identifier is stored in the storage;
transmit, when the cache data is stored in the storage, to a transmission source of the first request, a first response including the cache data;
transmit, when the cache data is not stored in the storage, to the server, a second request acquired by deleting the identifier from the first request and transmitting, to the server, a third request for requesting the acquisition of the data;
transmit, when a second response to the second request is received from the server, to the transmission source of the first request, the second response; and
store, when a third response to the third request is received from the server, as the cache data, the data included in the third response in association with the identifier in the storage.
